(19) United States
(12) Patent Application Publication
(10) Pub. No.: US 2021/0157304 A1
(43) Pub. Date: May 27, 2021

(54) METHOD AND SYSTEM FOR DELIVERING MANAGEMENT

(71) Applicants: HKC Corporation Limited, Shenzhen, Guangdong (CN); Chongqing HKC Optoelectronics Technology Co., Ltd., Chongqing (CN)

(72) Inventor: Po-Sung Pan, Chongqing (CN)

(21) Appl. No.: 16/330,374

(22) PCT Filed: Dec. 20, 2017
(86) PCT No.: PCT/CN2017/117309

§ 371 Date: Mar. 5, 2019

(30) Foreign Application Priority Data
Feb. 23, 2017 (CN) 201710100405.6

(51) Int. Cl. G05B 19/418; G06Q 10/08

(52) U.S. Cl. CPC G05B 19/41865; G06Q 10/0833; G05B 2219/31309; G05B 2219/31277; G06Q 10/087

(57) ABSTRACT

Disclosed a method and a system for delivering management, and the method includes: monitoring a delivering information received by a manufacturing execution device according to a preset period (S11); determining whether the delivering information of the manufacturing execution device is updated (S12); if yes, sending an updated delivering information to a material controlling device (S13); performing feature content identification on the updated delivering information (S14); marking priority to the delivering information according to the identified feature content (S15); and performing delivering work according to the marked priority (S16). Monitoring a delivering information received by a manufacturing execution device according to a preset period, sending an updated delivering information to a material controlling device, performing feature content identification on the delivering information of a to be delivered product, marking a delivering priority, thus the delivering efficiency of the transportation system is improved and delivering costs are saved.

### TECHNICAL FIELD

The present disclosure relates to the field of automated material processing technology, and more particularly relates to a method and a system for delivering management.

### BACKGROUND

At present, when a manufacturing execution system (MES) gives a product-delivering instruction to a material control system (MCS), with the instruction content of delivering a product from one location to another, and the material control system (MCS) performs the delivering according to the order of the instructions. Because the insufficient information for the MCS to judge, it will cause the MCS to deliver the products that are not fully batched or the products with less urgent process interval time (Q-TIME), and resulting in poor production efficiency and handling efficiency.

### SUMMARY

The embodiment of the present application provides a method for delivering management, which can improve the delivering efficiency of the transportation system and save delivering costs.

In one aspect, the embodiment of the present disclosure provides a method for delivering management includes the following operations:

monitoring a delivering information received by a manufacturing execution device according to a preset period;

determining whether the delivering information of the manufacturing execution device is updated;

if yes, sending an updated delivering information to a material controlling device;

performing feature content identification on the updated delivering information;

marking priority to the delivering information according to the identified feature content; and

performing delivering work according to the marked priority.

In another aspect, the embodiment of the present disclosure provides a method for delivering management includes the following operations:

monitoring a delivering information received by a manufacturing execution device according to a preset time period;

determining whether the delivering information of the manufacturing execution device is updated;

if yes, sending an updated delivering information to a material controlling device;

performing feature content identification on the updated delivering information;

marking priority to the delivering information according to the identified feature content; and

performing delivering work according to the marked priority.

In a further aspect, the embodiment of the present disclosure provides a system for handling an order, the system includes:

a monitoring module, being configured to monitor a delivering information received by a manufacturing execution device according to a preset period;

a first determining module, being configured to determine whether the delivering information in the manufacturing execution device is updated;

an updating module, being configured to send an updated delivering information to a material controlling device if yes;

an identifying module, being configured to perform feature content identification on the updated delivering information;

an marking module, being configured to mark priority to the delivering information according to the identified feature content; and

a performing module, being configured to perform delivering work according to the marked priority.

The method and system for delivering management of the embodiment of the present application monitoring a delivering information received by a manufacturing execution device according to a preset period, sending an updated delivering information to a material controlling device, performing feature content identification on the updated delivering information, marking priority to the delivering information according to the identified feature content. Thereby improving the efficiency of the delivering system and saving the delivering cost.

### BRIEF DESCRIPTION OF THE ACCOMPANYING DRAWINGS

To illustrate the technical scheme of the embodiment of the present application more clearly, a brief description of the drawings to be used in the description of the embodiment will be given below. Obviously, the drawings described below are some of the embodiments of the application and, for those of ordinary skill in the art, may be used without creative effort. Other drawings are obtained based on these drawings.

FIG. 1 is a schematic flowchart of a method for delivering management in accordance with this disclosure;

FIG. 2 is a schematic flowchart of a method for delivering management in accordance with this disclosure;

FIG. 3 is a schematic flowchart of a method for delivering management in accordance with this disclosure;

FIG. 4 is a schematic block diagram of a system for delivering in accordance with this disclosure;

FIG. 5 is a schematic block diagram of a system for delivering in accordance with this disclosure;

FIG. 6 is a schematic block diagram of a system for delivering in accordance with this disclosure.

### DETAILED DESCRIPTION OF ILLUSTRATIVE EMBODIMENTS

The technical schemes in the embodiments of the present application are clearly and completely described in the following embodiments with drawings of the present application. It is obvious that the described embodiments are a part, not all, of the embodiments of the present application. All other embodiments obtained by an ordinary skilled person in the art based on the embodiments of the present application without departing from the inventive scope are fall into the scope of the present application.

The terms “comprise” and “include”, when used in the specification and the claims of this disclosure, indicating the presence of the described features, wholes, steps, operations, elements and/or components. However, the existence or addition of one or more other features, wholes, steps, operations, elements and/or components thereof are not excluded.

It is also appreciated that the terms used herein is for the purpose of describing particular embodiments and is not intended to be limiting it. As used in the specification and the attached claims of this disclosure, the singular terms “a”, “one” and “this” are intended to include the plural unless the context clearly specifies otherwise.

As used in the specification and the attached claims, the term “if” can be interpreted as “when” or “once” or “in response to determining” or “in response to detecting” depending on the context. Similarly, the phrase “if determined” or “if detected [condition or event described]” may be interpreted in context to mean “once determined” or “in response to detecting [condition or event described]” or “once detected [the described condition or event]” or “in response to determining”.

It should also be understood that although the terms “first”, “second”, etc. may be used herein to describe various elements, these elements should not be limited to these terms. These terms are only used to distinguish these elements from each other. For example, a first terminal may be referred to as a second terminal without departing from the scope of this disclosure, and similarly, a second terminal may be referred to as a first terminal. The first terminal and the second terminal are both terminals, but they are not the same terminal.

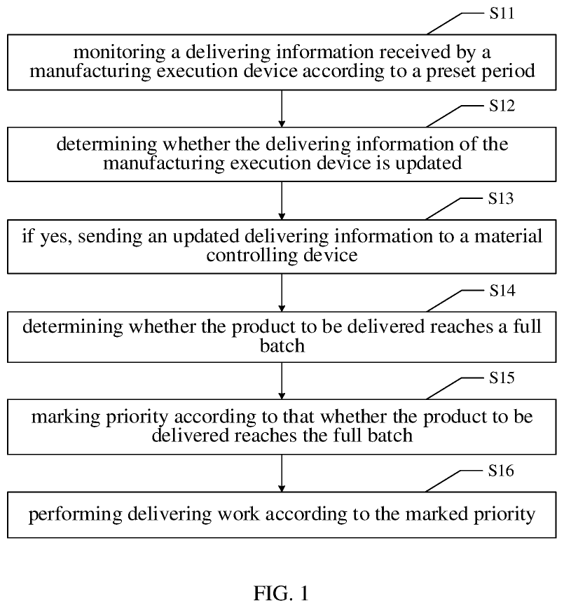

FIG. 1 is a schematic flowchart of a method for delivering management in accordance with this disclosure. As shown in the figure, the method includes the following steps S11 to S16.

In S11, monitoring a delivering information received by a manufacturing execution device according to a preset period.

Specifically, the manufacturing execution device receives the delivering information, for example, collecting, integrating, and applying various production information of a factory site. The system monitors the delivering information according to a preset time period to obtain the current delivering information. In specific, the time period can be set freely, such as monitoring the delivering information every 1 minute.

Further, the preset period may also be a space period, for example, a certain space period can be defined as from a delivering device reaches a preset position to reach the same preset location again. That is, in this embodiment, when the delivering device reaches the preset position each time, the delivering information received by the manufacturing execution device is monitored. This prevents the device from performing unnecessary repeated monitoring actions.

In S12, determining whether the delivering information of the manufacturing execution device is updated.

Specifically, the system determines whether the delivering information of the manufacturing execution device is updated. That is, the delivering information is monitored by the monitoring device as described above, and it is determined whether the current monitoring result is the same as the previous monitoring result.

In S13, if yes, sending an updated delivering information to a material controlling device.

Specifically, if it is detected that the delivering information of the manufacturing execution device is updated. That is, the current monitoring result is found to be different from the previous monitoring result, the updated delivering information (currently monitored delivering information) is sent to the material control device.

In S14, determining whether the product to be delivered reaches a full batch.

Specifically, before delivering the products, the delivering information received by the manufacturing execution device is used to confirm which products belong to the same batch, and whether the batch of products is full or not is judged and recognized.

In S15, performing priority marking according to whether the product reaches a full batch.

Specifically, if it is recognized that the same batch of products is full, the products of the batch are prioritized and marked as preferentially transported.

In S16, performing delivering work according to the marked priority.

Specifically, during transportation, the delivering work is performed according to the marked priority. If the product is already full, the full batch of products is marked priority and preferentially delivered. By judging whether the product batch to be delivered is full or not, and priority delivering the full batch of products with priority marking, which can maintain the time of the machine's run status, and avoiding the idling time becomes longer and the number of delivering times increases of the machine caused by the delivering of unfilled batches of products, thereby improving the working efficiency of the machine and saving costs.

Further, if multiple groups of products reach the full batch at the same time, obtaining a single group time duration required for each group of products to be delivered; and the operation of marking priority to the delivering information according to the identified feature content is performed as marking the product corresponding to the single group time duration.

Specifically, it is not possible to deliver the product at the time when the product is ready for delivering. If there are multiple sets of products reaching the full batch during the period from the products to be transported reaches full batch to the machine performs delivering. The time required to delivering completely of the products will be judged. The priority of the full batch of products to be delivered is marked. The shorter the time required to deliver, the higher the priority. For example, there are three groups of products A, B and C are reaches full batch at the same time, and waiting for delivering. And the delivering time of the three groups of products is k, m, n (where k>m>n) corresponding to A, B and C respectively. Thus C group products with the delivering time n are marked with priority, that is, the C group products are preferentially transported. So that the waiting time for the next group of products can be reduced, and the efficiency of entrance into subsequent processes is improved.

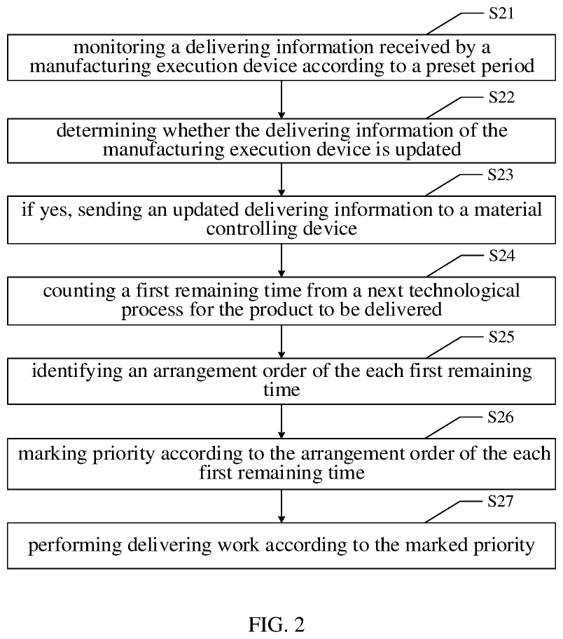

FIG. 2 is a schematic flowchart of a method for delivering management in accordance with this disclosure. As shown in the figure, the method includes the following steps S21 to S27.

In S21, monitoring a delivering information received by a manufacturing execution device according to a preset period.

Specifically, the manufacturing execution device receives the delivering information, for example, collecting, integrating, and applying various production information of a factory site. The system monitors the delivering information according to a preset time period to obtain the current delivering information. In specific, the time period can be set freely, such as monitoring the delivering information every 1 minute.

In S22, determining whether the delivering information of the manufacturing execution device is updated.

Specifically, the system determines whether the delivering information of the manufacturing execution device is updated. That is, the delivering information is monitored by the monitoring device as described above, and it is determined whether the current monitoring result is the same as the previous monitoring result.

In S23, if yes, sending an updated delivering information to a material controlling device.

Specifically, if it is detected that the delivering information of the manufacturing execution device is updated. That is, the current monitoring result is found to be different from the previous monitoring result, the updated delivering information (currently monitored delivering information) is sent to the material control device.

In S24, counting a first remaining time from a next technological process for the product to be delivered.

Specifically, the first remaining time is an intermittent time (Q-time) between the end of one process step and the beginning of the next process step, where the specific intermittent time of each group of products is counted.

In S25, identifying an arrangement order of the each first remaining time.

Specifically, after identifying the specific first remaining time (the remaining time of Q-time), the first remaining time is arranged according to the specific first remaining time.

In S26, marking priority according to the arrangement order of the each first remaining time.

Specifically, the products to be delivered are marked according to the order of the specific time of the first remaining time, and the less first remaining time has higher marking priority.

In S27, performing delivering work according to the marked priority.

Specifically, during the transportation, the delivering operation is performed according to the marked priority. The products with less first remaining time is marked as priority delivering. In actual transportation, priority marked product is preferentially transported, prior to other products with more first remaining time. By judging the length of the first remaining time of the product to be delivered (that is, the remaining time of Q-time), the products with the shorter Q-time are priority delivered. So that it is possible to avoid carrying products with sufficient Q-time time though make some products exceeding the Q-time, and the products that exceed Q-time need to go back to rework. Thus avoiding an increase in manufacturing costs and improving delivering efficiency.

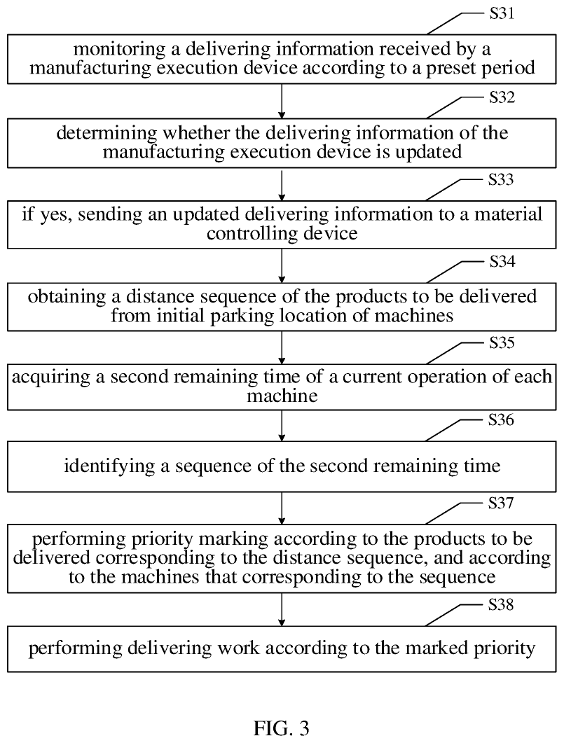

FIG. 3 is a schematic flowchart of a method for delivering management in accordance with this disclosure. As shown in the figure, the method includes the following steps S31 to S38.

In S31, monitoring a delivering information received by a manufacturing execution device according to a preset period.

Specifically, the manufacturing execution device receives the delivering information, for example, collecting, integrating, and applying various production information of a factory site. The system monitors the delivering information according to a preset time period to obtain the current delivering information. In specific, the time period can be set freely, such as monitoring the delivering information every 1 minute.

S32, determining whether the delivering information of the manufacturing execution device is updated.

Specifically, the system determines whether the delivering information of the manufacturing execution device is updated. That is, the delivering information is monitored by the monitoring device as described above, and it is determined whether the current monitoring result is the same as the previous monitoring result.

In S33, if yes, sending an updated delivering information to a material controlling device.

Specifically, if it is detected that the delivering information of the manufacturing execution device is updated. That is, the current monitoring result is found to be different from the previous monitoring result, the updated delivering information (currently monitored delivering information) is sent to the material control device.

In S34, obtaining a distance sequence of the products to be delivered from initial parking location of machines.

Specifically, the distance between each product to be delivered and the initial parking location of the machines is monitored, and the order is arranged according to the each distance.

In S35, acquiring a second remaining time of a current operation of each machine.

Specifically, a second remaining time is the remaining time from the end of the current operation of the machine, and remaining time from the end of the current operation of each machine is collectively classified.

In S36, identifying a sequence of the second remaining time.

Specifically, the remaining time of the current operation of each machine is arranged according to the length of time.

In S37, performing priority marking according to the products to be delivered corresponding to the distance sequence, and according to the machines that corresponding to the sequence.

Specifically, the products corresponding to the distance sequence are marked according to the remaining time sequence of the current machine operation, and the specific sequence is that the remaining time from the end of the operation is from short to long corresponding to the product from the near to far distance from the machine.

In S38, performing delivering work according to the marked priority.

Specifically, during transportation, the delivering operation is performed according to the marked priority, that is, the shortest current remaining operation time of the machine is marked corresponding to the closest distance to initial parking location of the machine, and the machine that firstly reaches the standby(idle) delivers the product closest to the initial parking location of the machine. By judging the time of the machine from the idle, and marking the product to be transported that is closest to the initial parking location correspondingly, the time of the machine's running status can be maintained. The condition that one machine is delivering with waiting products, and another machine is idle is avoided, which improves the working efficiency of the machine.

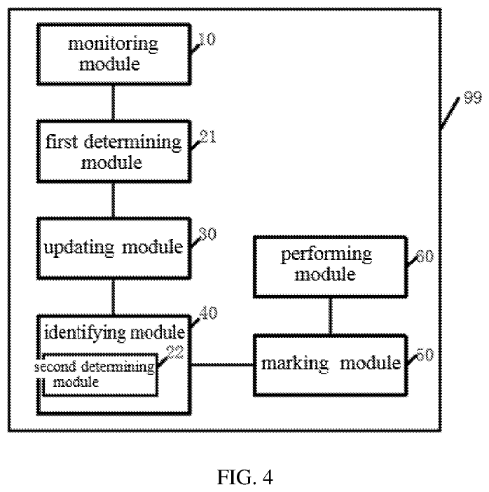

FIG. 4 is a schematic block diagram of a system for delivering in accordance with this disclosure. As shown in the figure, the system includes following parts.

A monitoring module 10, being configured to monitor a delivering information received by a manufacturing execution device according to a preset period.

A first determining module 21, being configured to determine whether the delivering information in the manufacturing execution device is updated.

An updating module 30, being configured to send an updated delivering information to a material controlling device if yes.

An identifying module 40, being configured to perform feature content identification on the updated delivering information, including a second determining module 22.

A second determining module 22, being configured to determine whether the product to be delivered reaches a full batch.

A marking module 50, being configured to perform priority marking according to whether the product reaches a full batch.

A performing module 60, being configured to perform delivering work according to the marked priority.

Specifically, when the system 99 is in operation, the monitoring module 10 monitors the delivering information in the manufacturing execution device according to the preset period, and the first determining module 21 determines whether the delivering information in the manufacturing execution device is updated, if there is an update. Then, the updated delivering information is sent to the material control device by the updating module 30, and the second determining module 22 determines whether the product to be delivered reaches a full batch by identifying the delivering information, and the marking module 50 performs priority marking according to whether the product batch is full or not. The delivering operation is ultimately carried out by the performing module 60 based on the marked priority.

By judging whether the product batch to be delivered is full or not, and priority delivering the full batch of products with priority marking, which can maintain the time of the machine's run status, and avoiding the idling time becomes longer and the number of delivering times increases of the machine caused by the delivering of unfilled batches of products, thereby improving the working efficiency of the machine and saving costs.

Further, the system may further includes following parts.

A first obtaining module 71, being configured to obtaining a single group time duration required for each group of products to be delivered, if multiple groups of products reach the full batch at the same time; and the marking module 50 is configured to perform priority marking according to the product corresponding to the single group time duration.

Specifically, it is not possible to deliver the product at the time when the product is ready for delivering. If there are multiple sets of products reaching the full batch during the period from the products to be transported reaches full batch to the machine performs delivering. The time required to delivering completely of the products will be judged. The priority of the full batch of products to be delivered is marked. The shorter the time required to deliver, the higher the priority. For example, there are three groups of products A, B and C are reaches full batch at the same time, and waiting for delivering. And the delivering time of the three groups of products is k, m, n (where k>m>n) corresponding to A, B and C respectively. Thus C group products with the delivering time n are marked with priority, that is, the C group products are preferentially transported. So that the waiting time for the next group of products can be reduced, and the efficiency of entrance into subsequent processes is improved.

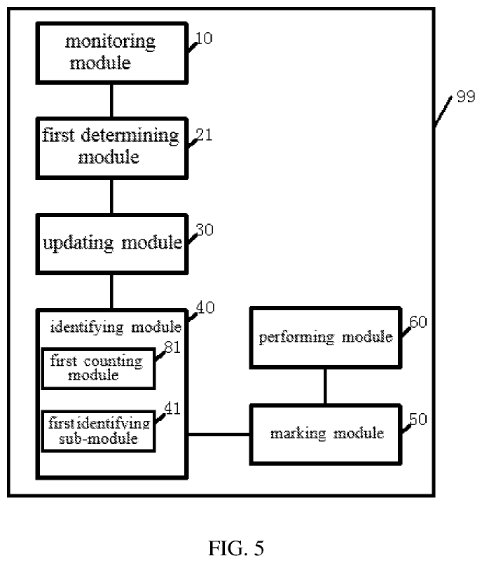

FIG. 5 is a schematic block diagram of a system for delivering in accordance with this disclosure. As shown in the figure, the system includes following parts.

A monitoring module 10, being configured to monitor a delivering information received by a manufacturing execution device according to a preset period.

A first determining module 21, being configured to determine whether the delivering information in the manufacturing execution device is updated.

An updating module 30, being configured to send an updated delivering information to a material controlling device if yes.

An identifying module 40, being configured to perform feature content identification on the updated delivering information, including first counting module 81 and a first identifying sub-module 41.

A first counting module 81, being configured to count a first remaining time from a next technological process for the product to be delivered.

A first identifying sub-module 41, being configured to identify an arrangement order of the first remaining time.

The marking module 50 is configured to marking priority according to whether the arrangement order of the first remaining time.

A performing module 60, being configured to perform delivering work according to the marked priority.

Specifically, when the system 99 is in operation, the monitoring module 10 monitors the delivering information in the manufacturing execution device according to the preset period, and the first determining module 21 determines whether the delivering information in the manufacturing execution device is updated, if there is an update. Then, the updated delivering information is sent to the material control device by the updating module 30, and the first counting module 81 counts the first remaining time from a next technological process for the product to be delivered, after the first identifying sub-module 41 identify an arrangement order of the first remaining time, the marking module 50 marking priority according to whether the arrangement order of the first remaining time. The delivering operation is ultimately carried out by the performing module 60 based on the marked priority.

By judging the length of the first remaining time of the product to be delivered (that is, the remaining time of Q-time), the products with the shorter Q-time are priority delivered. So that it is possible to avoid carrying products with sufficient Q-time time though make some products exceeding the Q-time, and the products that exceed Q-time need to go back to rework. Thus avoiding an increase in manufacturing costs and improving delivering efficiency.

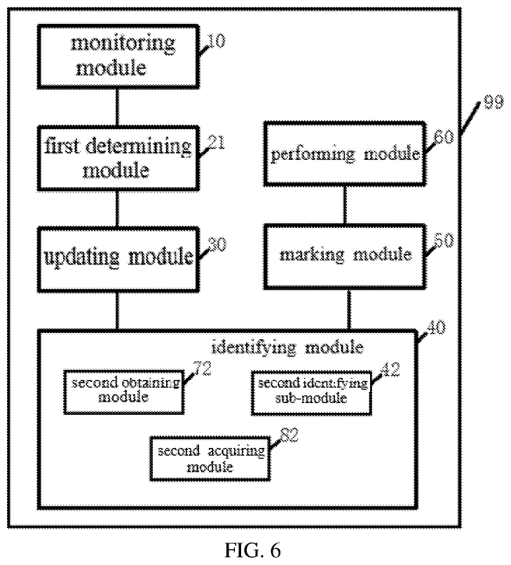

FIG. 6 is a schematic block diagram of a system for delivering in accordance with this disclosure. As shown in the figure, the system includes following parts.

A monitoring module 10, being configured to monitor a delivering information received by a manufacturing execution device according to a preset period.

A first determining module 21, being configured to determine whether the delivering information in the manufacturing execution device is updated.

An updating module 30, being configured to send an updated delivering information to a material controlling device if yes.

An identifying module 40, being configured to perform feature content identification on the updated delivering information, including a second obtaining module 72, second acquiring module 82, and a second identifying sub-module 42.

A second obtaining module 72, being configured to obtain a distance sequence of the products to be delivered from initial parking location of machines.

A second acquiring module 82, being configured to acquire a second remaining time of a current operation of each machine.

A second identifying sub-module 42, being configured to identify a sequence of the second remaining time.

The marking module 50 is configured to perform priority marking according to the products to be delivered corresponding to the distance sequence, and according to the machines that corresponding to the sequence.

A performing module 60, being configured to perform delivering work according to the marked priority.

Specifically, when the system 99 is in operation, the monitoring module 10 monitors the delivering information in the manufacturing execution device according to the preset period, and the first determining module 21 determines whether the delivering information in the manufacturing execution device is updated, if there is an update. Then, the updated delivering information is sent to the material control device by the updating module 30, and the second obtaining module 72 obtains a distance sequence of the products to be delivered from initial parking location of machines. The second acquiring module 82 acquires a second remaining time of a current operation of each machine. The second identifying sub-module 42 identifies a sequence of the second remaining time. The marking module 50 perform priority marking according to the products to be delivered corresponding to the distance sequence, and according to the machines that corresponding to the sequence. The delivering operation is ultimately carried out by the performing module 60 based on the marked priority.

By judging the time of the machine from the idle, and marking the product to be transported that is closest to the initial parking location correspondingly, the time of the machine's running status can be maintained. The condition that one machine is delivering with waiting products, and another machine is idle is avoided, which improves the working efficiency of the machine.

In the above embodiments provided in this disclosure, it should be understood that the disclosed methods are merely illustrative and may be implemented in other manners.

It should be noted that the operations in the embodiments of this disclosure, may be sequentially adjusted, merged, and deleted according to actual needs.

The units in the terminal of the embodiments of this disclosure may be combined, divided, and deleted according to actual needs.

The foregoing description merely portrays some illustrative embodiments according to the disclosure and therefore is not intended to limit the patentable scope of the disclosure. Any equivalent structural or flow transformations that are made taking advantage of the specification and accompanying drawings of the disclosure and any direct or indirect applications thereof in other related technical fields shall all fall in the scope of protection of the disclosure. Therefore, the scope of protection of this disclosure shall be subject to the claims.

What is claimed is:

1. A method for delivering management, wherein the method comprises:
monitoring a delivering information received by a manufacturing execution device according to a preset period;
determining whether the delivering information of the manufacturing execution device is updated;
if yes, sending an updated delivering information to a material controlling device;
performing feature content identification on the updated delivering information;
marking priority to the delivering information according to the identified feature content; and
performing delivering work according to the marked priority.

2. The method of claim 1, wherein the operation of performing feature content identification on the updated delivering information comprises:
determining whether the product to be delivered reaches a full batch; and
if yes, the operation of marking priority to the delivering information according to the identified feature content is performed as marking priority according to that whether the product to be delivered reaches the full batch.

3. The method of claim 2, further comprises:
if multiple groups of products reach the full batch at the same time, obtaining a single group time duration required for each group of products to be delivered; and
the operation of marking priority to the delivering information according to the identified feature content is performed as marking the product corresponding to the single group time duration.

4. The method of claim 1, wherein the operation of performing feature content identification on the updated delivering information comprises:
counting a first remaining time from a next technological process for the product to be delivered;
identifying an arrangement order of the first remaining time; and
the operation of marking priority to the delivering information according to the identified feature content is performed as marking priority according to the arrangement order of the first remaining time.

5. The method of claim 1, wherein the operation of performing feature content identification on the delivering information further comprises:
obtaining a distance sequence of the products to be delivered from initial parking location of machines;
acquiring a second remaining time of a current operation of each machine;
identifying a sequence of the second remaining time; and
the operation of marking priority to the delivering information according to the identified feature content is performed as marking priority of the products to be delivered corresponding to the distance sequence, and according to the machines that corresponding to the sequence.

6. The method of claim 1, wherein the operation of performing feature content identification on the updated delivering information comprises:
counting a first remaining time from a next technological process for the product to be delivered;
identifying an arrangement order of the first remaining time;
obtaining a distance sequence of the products to be delivered from initial parking location of machines;
acquiring a second remaining time of a current operation of each machine;
identifying a sequence of the second remaining time; and
the operation of marking priority to the delivering information according to the identified feature content is performed as marking priority of the products to be delivered corresponding to the distance sequence, and according to the machines that corresponding to the sequence.

7. The method of claim 1, the preset period comprises a preset time period.

8. A method for delivering management, wherein the method comprises:
determining whether a delivering equipment has reached a preset location;
if yes, monitoring a delivering information received by a manufacturing execution device according to a preset period;
determining whether the delivering information of the manufacturing execution device is updated;
if yes, sending an updated delivering information to a material controlling device;
performing feature content identification on the updated delivering information;
marking priority to the delivering information according to the identified feature content; and
performing delivering work according to the marked priority.

9. The method of claim 8, wherein the operation of performing feature content identification on the updated delivering information comprises:
determining whether the product to be delivered reaches a full batch; and
if yes, the operation of marking priority to the delivering information according to the identified feature content is performed as marking priority according to that whether the product to be delivered reaches the full batch.

10. The method of claim 9, further comprises:
if multiple groups of products reach the full batch at the same time, obtaining a single group time duration required for each group of products to be delivered;
the operation of marking priority to the delivering information according to the identified feature content is performed as marking the product corresponding to the single group time duration.

11. The method of claim 8, wherein the operation of performing feature content identification on the delivering information further comprises:
obtaining a distance sequence of the products to be delivered from initial parking location of machines;
acquiring a second remaining time of a current operation of each machine;
identifying a sequence of the second remaining time; and
the operation of marking priority to the delivering information according to the identified feature content is performed as marking priority of the products to be delivered corresponding to the distance sequence, and according to the machines that corresponding to the sequence.

12. The method of claim 8, wherein the operation of performing feature content identification on the delivering information further comprises:
determining whether the product to be delivered reaches a full batch; and
if multiple groups of products reach the full batch at the same time, obtaining a distance sequence of the products to be delivered from initial parking location of machines;
acquiring a second remaining time of a current operation of each machine;
identifying a sequence of the second remaining time; and
the operation of marking priority to the delivering information according to the identified feature content is performed as marking priority of the products to be delivered corresponding to the distance sequence, and according to the machines that corresponding to the sequence.

13. The method of claim 8, wherein the operation of performing feature content identification on the updated delivering information comprises:
counting a first remaining time from a next technological process for the product to be delivered;
identifying an arrangement order of the first remaining time;
determining whether the product to be delivered reaches a full batch; and
If yes, the operation of marking priority to the delivering information according to the identified feature content is performed as marking priority according to whether the product to be delivered reaches a full batch and the arrangement order of the first remaining time.

14. A system for delivering, wherein the system comprises:
a monitoring module, being configured to monitor a delivering information received by a manufacturing execution device according to a preset period;
a first determining module, being configured to determine whether the delivering information in the manufacturing execution device is updated;
an updating module, being configured to send an updated delivering information to a material controlling device if yes;
an identifying module, being configured to perform feature content identification on the updated delivering information;
an marking module, being configured to mark priority to the delivering information according to the identified feature content; and
a performing module, being configured to perform delivering work according to the marked priority.

15. The system of claim 14, wherein the identifying module of performing feature content identification on the updated delivering information comprises:
a second determining module, being configured to determine whether the product to be delivered reaches a full batch; and
the marking module is configured to perform priority marking according to whether the product reaches a full batch.

16. The system of claim 15, further comprises:
a first obtaining module, being configured to obtaining a single group time duration required for each group of products to be delivered, if multiple groups of products reach the full batch at the same time; and
the marking module is configured to perform priority marking according to the product corresponding to the single group time duration.

17. The system of claim 14, further comprises:
a second obtaining module, being configured to obtain a distance sequence of the products to be delivered from initial parking location of machines;
a second acquiring module, being configured to acquire a second remaining time of a current operation of each machine;
an second identifying sub-module, being configured to identify a sequence of the second remaining time; and
the marking module is configured to perform priority marking according to the products to be delivered corresponding to the distance sequence, and according to the machines that corresponding to the sequence.

18. The system of claim 14, wherein the operation of performing feature content identification on the updated delivering information comprises:
a first counting module, being configured to count a first remaining time from a next technological process for the product to be delivered;
an first identifying sub-module, being configured to identify an arrangement order of the first remaining time;
a second determining module, being configured to determine whether the product to be delivered reaches a full batch; and
the marking module is configured to marking priority according to whether the product to be delivered reaches a full batch and the arrangement order of the first remaining time.

19. The system of claim 18, further comprises:
a first obtaining module, being configured to obtaining a single group time duration required for each group of products to be delivered, if multiple groups of products reach the full batch at the same time; and
the marking module is configured to marking priority according to the single group time duration and the arrangement order of the first remaining time.

20. The system of claim 14, wherein the operation of performing feature content identification on the updated delivering information further comprises:
a first counting module, being configured to count a first remaining time from a next technological process for the product to be delivered;
an first identifying sub-module, being configured to identify an arrangement order of the first remaining time;
a second obtaining module, being configured to obtain a distance sequence of the products to be delivered from initial parking location of machines;
a second acquiring module, being configured to acquire a second remaining time of a current operation of each machine;
an second identifying sub-module, being configured to identify a sequence of the second remaining time; and
the marking module is configured to perform priority marking according to the products to be delivered corresponding to the distance sequence, and according to the machines that corresponding to the sequence.
